(19) United States
(12) Patent Application Publication
(10) Pub. No.: US 2012/0261149 A1
(43) Pub. Date: Oct. 18, 2012

(54) FLOATING APPARATUS FOR CLEARING CROP DEBRIS

(76) Inventor: Eugene H. Schmidt, Madrid, NE (US)

(21) Appl. No.: 13/087,896

(22) Filed: Apr. 15, 2011

(51) Int. Cl. A01B 15/16

(52) U.S. Cl. 172/558

(57) ABSTRACT

A debris clearing apparatus for use with a farm implement tool bar with at least one trailing planter row unit, includes a frame extension connectable to the row unit and having a forward projecting mounting point relative to a direction of travel, the mounting point including first and second pivot mounts defining transverse pivot points. A parallelogram linkage has two arms, each arm having a first pivot connection for attachment to one of the first and second mounts and an opposite second pivot connection. A debris clearing module is attachable to the opposite second pivot connections behind the mounting point in the direction of travel, the module having a foot structure for supporting at least one disk mount having at least one clearing disk. The parallelogram linkage enables the debris-clearing module to generally float behind the mounting point as the implement is pulled in the direction of travel.

### BACKGROUND

The present invention relates generally to tillage equipment used for planting and cultivating row crops, and more specifically to rotating disk row cleaners used in no-till or limited till farming operations.

It is well known that the emergence of row crop seeds, particularly corn, is greatly dependent upon the spacing, depth and placement of the seed in the seedbed. Since seed planting depth is a function of the engagement of the planter wheel upon the seedbed, if the planter gauge wheel encounters trash or crop residue left on the field, such as corn stalks, leaves, ears, weed debris or the like from the prior season, it may lose contact with the seedbed and move upward, taking the planter with it, and thus improperly placing the seed. It is also well known that application of herbicides, particularly the preemergent variety, is impaired if the herbicides are applied to crop debris instead of upon the soil itself.

The use of rotating, toothed disks, in some cases having a dished or concave configuration for clearing debris prior to planting in no-till or limited-till farming operations is disclosed in commonly-assigned U.S. Pat. No. 6,279,666 which is incorporated by reference. Such tillage units include a pair of disks, each angled relative to a direction of travel to form a general “V”-shape, with the apex of the “V” generally pointing in the direction of travel. In the '666 patent, it is disclosed that enhanced results are obtained by mounting the disks to a support bracket such that the disks are spaced from each other a specified distance in the direction of travel.

One of the drawbacks of the unit described in the '666 patent and others of its type is that when mounted to a row crop planting unit, or other tillage implement having or connected to a transverse or generally horizontally-mounted tool bar, when pulled by a tractor or the like over uneven ground, the debris clearing units have been known to lose contact with the ground surface, and as such incompletely clearing debris away from portions of the row to be planted. In other instances, the tillage unit bottoms out on the ground surface after being momentarily airborne, and as a result creates gouges in the planting surface. As the planter reaches this incompletely cleared or gouged area, it is more difficult to properly place the seed, and as such, germination rates, and ultimately crop yield rates suffer as a result of the incomplete clearance of debris.

Since the development of the invention of the '666 patent, the industry has developed tillage units with spring biased, vertically movable workheads that compensate for undulations in uneven ground. While these units have reduced many of the instances of debris clearing units losing contact with the seedbed, problems remain. For example, the angled disk wheels in some cases exert an uneven torque upon the disk mounting brackets, causing misalignment, incomplete clearing, and in some cases premature unit failure.

In other cases, vertically movable workhead units still cause gouging of the seedbed due to a mechanical under reaction or over reaction to surface undulations. Other conventional units have a single pivot point for attachment to row unit, and as such as the ground undulates, the angle of the clearing device changes relative to the ground. The single pivot point causes variations in the ground contour to change the angular position of the clearing device relative to the ground. Also, other conventional units are not vertically movable themselves to accommodate ground undulations, but instead rely upon the alignment-maintenance system of the planter to ensure ground contact.

Further, the orientation of conventional row cleaners to the tool bar or planter unit causes the row cleaners to sink into the seedbed. Some units have added gauging devices to prevent this unwanted sinking action. Such devices tend to hold or collect field crop debris instead of moving such material away from the row cleaner, and also cause the row cleaner to ride over minor undulations in the field such as gopher mounds. In these situations, the row unit will bounce over the gopher mound, causing inconsistent seed depth and subsequent unwanted variation of growing conditions for the resulting seedling. These systems have proven unsatisfactory. Thus, there has been a need for crop debris clearing units which remain in contact with the ground, especially uneven ground, during operation.

### SUMMARY

The above-identified drawbacks of prior art crop debris clearing units are met or exceeded by the present floating apparatus for clearing crop debris. An important feature of the present apparatus is that it is “pulled” through the field, in other words is mounted at a forward mounting point extending forward in a direction of travel, and a disk-bearing debris clearing module projects rearwardly of the mounting point. Thus, the present apparatus is pulled, rather than pushed through the soil in the direction of travel. In addition, the debris-clearing unit is connected to the mounting point with a dual arm parallelogram linkage so that the unit floats generally vertically relative to the ground surface. The parallelogram linkage maintains constant position of the debris-clearing unit to the ground even when the surface undulates. Preferably, a biasing element exerts a downward biasing force on the debris-clearing unit to urge it into contact with the soil surface.

The present apparatus is provided in embodiments designed for mounting respectively to planter row units and other farm tillage implements, many of which having tool bars. In the case of the planter row unit, the present apparatus is configured for floating independently of the floating action of the planter row unit.

More specifically, a debris clearing apparatus is provided for use with a farm implement having a tool bar with at least one attached trailing planter row unit having a linkage that permits the planter row unit to generally float relative to the tool bar as the implement is pulled in a direction of travel. The apparatus includes a frame extension configured for connection to the at least one planter row unit and having a mounting point projecting forward from the planter row unit in the direction of travel, the mounting point including generally vertically spaced first and second pivot mounts defining generally transverse pivot points. A parallelogram linkage has two arms, each arm having a first pivot connection for attachment to a selected one of the first and second pivot mounts and an opposite second pivot connection. A debris clearing module is configured for attachment to the opposite second pivot connections of the two arms behind the mounting point in the direction of travel, and has a foot structure for supporting at least one disk mount for receiving at least one clearing disk. The parallelogram linkage is configured for enabling the debris-clearing module to generally float behind the mounting point as the implement is pulled in the direction of travel.

In another embodiment, a debris clearing apparatus is provided for use with a farm implement having a transverse tool bar and at least one trailing planter row unit attached to the tool bar with a linkage that permits the row unit to generally float relative to the tool bar as the implement is pulled in a direction of travel. The linkage is connected to a linkage mounting plate. The apparatus includes a frame extension attachable to the linkage mounting plate, and a mounting extension connected to the frame extension, depending from the mounting plate relative to the direction of travel and including a mounting point including generally vertically spaced first and second pivot mounts defining generally transverse pivot points. A parallelogram linkage has two arms, each arm having a first pivot connection for attachment to a selected one of the first and second mounts and an opposite second pivot connection. A debris-clearing module is configured for attachment to the opposite second pivot connections of the two arms behind the mounting point in the direction of travel so that the second connections are vertically displaced from each other. The module has a foot structure for supporting at least one disk mount for attaching at least one clearing disk thereto. The parallelogram linkage is configured for enabling the debris-clearing module to generally float behind and relative to the tool bar as the implement is pulled in the direction of travel.

In a further embodiment, a debris clearing apparatus is provided for use with a farm implement. The apparatus includes a frame extension constructed and arranged for attachment to the farm implement and having a mounting point projecting in the direction of travel, said mounting point including generally vertically spaced first and second pivot mounts defining generally transverse pivot points. The first pivot mount defines a bias mount accommodating a transversely oriented biasing element for biasing the parallelogram linkage in a downward direction. A parallelogram two arm linkage is also included, each arm having a first end pivot connection for attachment to the mounting extension and an opposite second end for accommodating a debris clearing module, the second end of each arm having a second end pivot connection.

Also included on the arms are a pair of upper and lower pivot arms that are located adjacent one another in a parallel relationship, spaced apart from one another a predetermined distance so that adjacent surfaces of the upper and lower pivot arms can rotate through a predetermined maximum arc relative to any of the first and second pivot connections, the predetermined maximum arc being limited by contact between adjacent stop formations of the upper and lower pivot arms, a biasing element-engaging surface provide opposite the flat surface on each said arm.

A debris clearing module is configured for attachment to the opposite second pivot connections of the two arms behind the mounting point in the direction of travel so that the second connections are vertically displaced from each other, having a foot structure for supporting at least a pair of disk mounts for attaching a pair of clearing disks thereto. The disk mounts being oriented to position each pair of disks to converge adjacent one another at a forward reach of the disks, a rearward reach of each disk being spaced apart from one another so that the general planes of the disks are angled outwardly from the forward reach to the rearward reach thereof, the disks are preferably secured to the foot structure to define a spacing in the direction of travel of a specified distance. The parallelogram linkage is configured for enabling the debris clearing module to generally float behind the mounting point as the implement is pulled in the direction of travel.

### BRIEF DESCRIPTION OF THE DRAWINGS

FIG. 1 is a side elevation of a planter row unit equipped with the present crop debris clearing apparatus;

FIG. 2 is a reverse side top perspective view of the crop debris clearing apparatus of FIG. 1;

FIG. 3 is an exploded top perspective view of the apparatus of FIG. 2;

FIG. 4 is a plan view of the apparatus of FIG. 2;

FIG. 5 is a fragmentary vertical cross-section of the apparatus of FIG. 2;

FIG. 6 is a side elevation of a planter row unit and implement tool bar equipped with another embodiment of the present crop debris clearing apparatus;

FIG. 7 is a top perspective view of the crop debris clearing apparatus of FIG. 6;

FIG. 8 is an enlarged fragmentary top perspective view of the apparatus of FIG. 6;

FIG. 9 is a side elevation of a planter row unit and implement tool bar equipped with a further embodiment the present crop debris clearing apparatus;

FIG. 10 is a rear top perspective view of the crop debris clearing apparatus of FIG. 9;

FIG. 11 is an enlarged fragmentary rear top perspective view of the apparatus of FIG. 10; and

FIG. 12 is a fragmentary top perspective view of the apparatus of FIG. 9.

### DETAILED DESCRIPTION

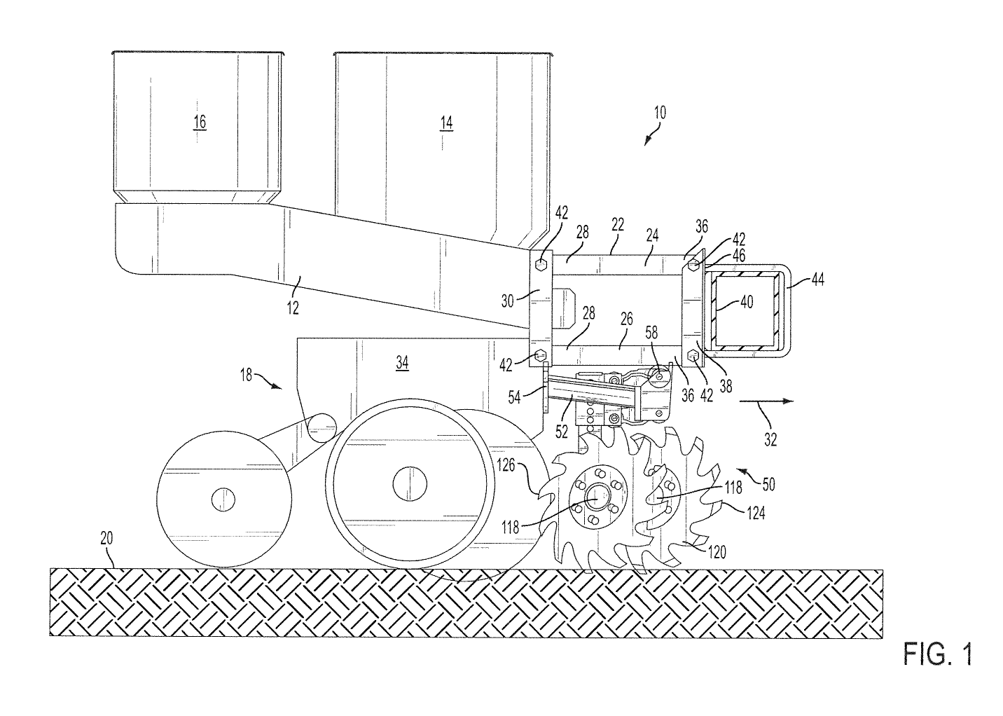

Referring now to FIG. 1, an agricultural planter row unit is generally designated 10 and is of the type conventionally used for planting row crops such as corn, soybeans and the like. Included on the row unit 10 is a frame 12, at least one seed box 14 for storing a supply of seeds to be planted, and an additive box 16 for storing a soil additive such as herbicide, fertilizer, insecticide or the like. A gauge wheel assembly 18 is connected to the frame 12 for controlling the depth at which the seeds are inserted into the soil 20. A planter parallel arm linkage 22 includes pairs of upper and lower laterally spaced arms, 24, 26 each pivotally connected at a rear end 28 to a front plate 30 of the frame 12. In the present application, “front” and “rear” will refer to an object's relation to a direction of travel, indicated by the arrow 32. Thus, “forward” will be understood to refer to something that is closer to the direction of travel.

It will be noted that the gauge wheel assembly 18 has a subframe 34 that is pivotally mounted to the front plate 30 independently of the frame 12 and is also connected to the lower arms 26 so that the gauge wheel assembly can pivot relative to undulations in the soil 20 while maintaining a relatively level orientation of the frame 12. Front ends 36 of the arms 24, 26 are pivotally connected to a planter linkage mounting plate 38 to allow the planter row unit 10 to generally float vertically relative to an implement tool, bar 40. It will be understood that the front plate 30, the parallel arm linkage 22 and the linkage mounting plate 38 are all considered part of the planter row unit 10. Thus, the linkage 22 has at least one set of four transverse pivot points 42 to maintain the desired floating action. As is known in the art, the implement tool bar 40 is constructed and arranged for being pulled through a field by a vehicle such as a tractor (not shown) in the direction of travel 32, is generally horizontally oriented, and is disposed transverse to the direction of travel. At least one and preferably a pair of laterally spaced “U”-bolts 44 encircle the tool bar 40 and are connected at respective free ends 46 to the mounting plate 38. Thus, as shown, the planter row unit 10 trails the tool bar 40 when the assembly is pulled in the direction of travel 32.

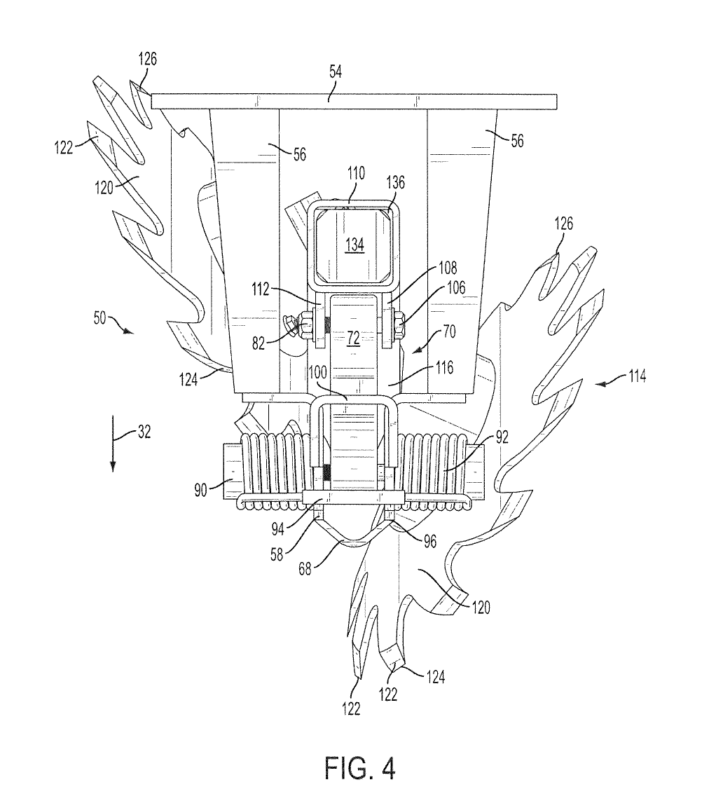

Referring now to FIGS. 1-5, the present debris clearing apparatus is generally designated 50 and is configured for being mounted directly to the planter row unit 10. In the preferred embodiment, the apparatus 50 is mounted to the gauge wheel subframe 34, however other locations are contemplated depending on the application. A frame extension 52 is generally box-shaped when viewed from above (FIG. 4). A rear plate 54 is mountable to the planter row unit 10 by at least one mounting aperture 55 and the frame extension 52 also has a pair of elongate, laterally spaced extension arms 56 connected at one end to the rear plate and at opposite ends defining a mounting point 58. As seen in FIG. 1, the mounting point 58 extends forwardly of the planter row unit 10 in the direction of travel 32.

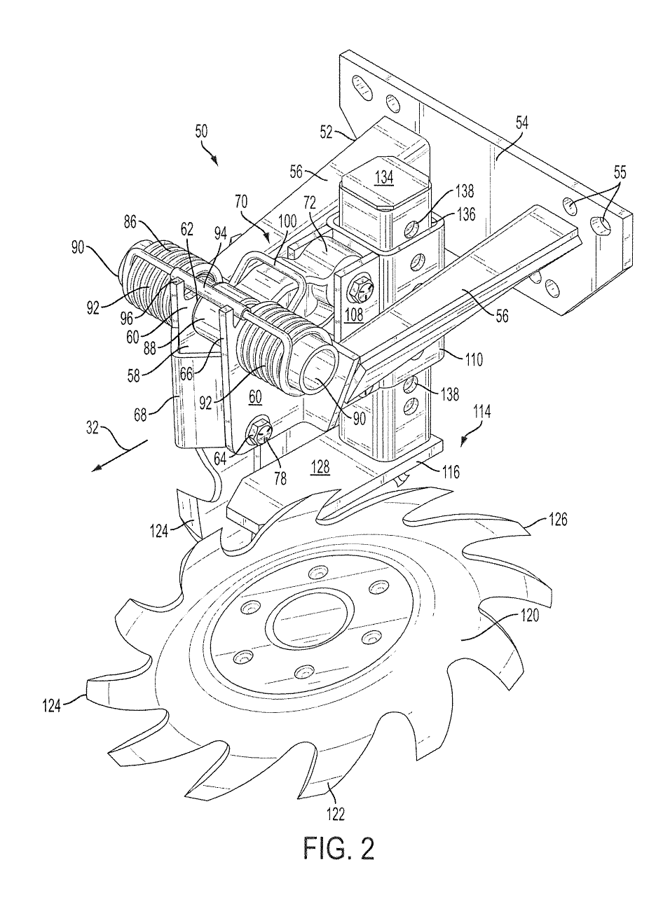

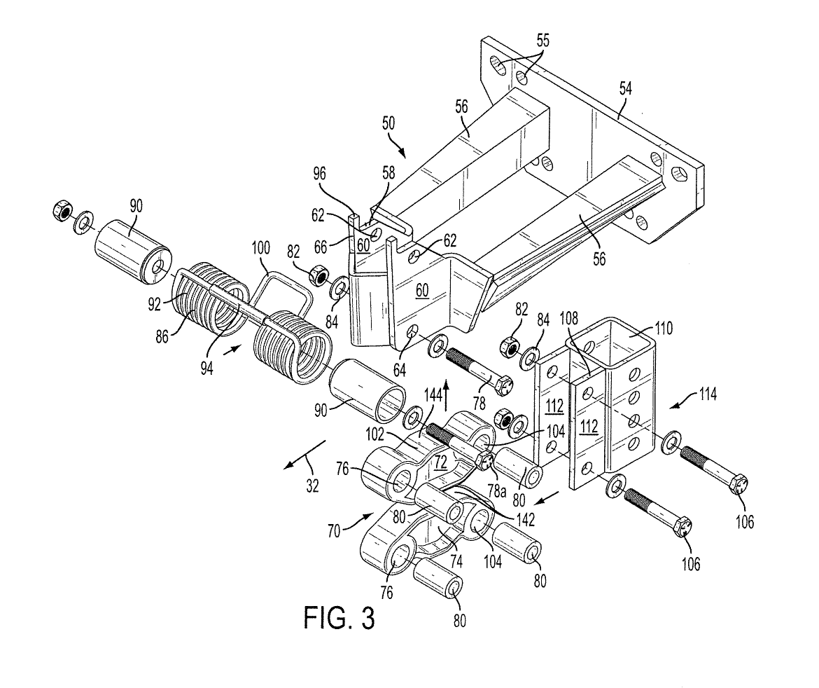

As best seen in FIG. 3, the mounting point 58 is formed by a pair of spaced apart, generally parallel, vertically extending first side plates 60 defining planes extending in the direction of travel 32. In the preferred embodiment, the side plates 60 each have vertically spaced first, upper and second, lower attachment points or pivot mounts 62, 64 each defining a pivot point which is transverse to the direction of travel 32. Forward edges 66 of the plates are preferably connected to each other by a connector member 68 (FIG. 2) for maintaining the spaced relationship of the plates. In the preferred embodiment, the connector member 68 is welded to the forward edges 66, however other attachment scenarios are contemplated as are known in the art, including fastening with bolts.

Referring now to FIGS. 2-5, mounted to the mounting point 58, specifically to the pivot mounts 62, 64 is a parallelogram linkage generally designated 70 having two arms, a first or upper arm 72 and a second or lower arm 74. Each arm 72, 74 has transverse throughbore 76 defining a first pivot connection for attachment to a selected one of the first and second pivot mounts 62, 64. Connection of the arms 72, 74 to the pivot mounts 62, 64 is preferably achieved using transverse threaded fasteners such as bolts 78 passing through reduced friction bushings 80 made of chrome plated steel or other metal, or composite bearing material or equivalent, and engaging the throughbores 76. The fasteners 78 are secured to the plates 60 using nuts 82 and washers 84 as are commonly known in the art. It will be appreciated that the vertical spacing of the pivot mounts, 62, 64 maintains a vertically spaced relationship of the arms 72, 74.

Also, the uppermost fastener 78a is used to secure a biasing element 86, preferably a torsion spring, to the pivot mount 62, which thus becomes a bias mount. The biasing element 86 is provided for biasing the parallelogram linkage 70 in a downward direction described in greater detail below. An end 88 of the arm 72 is preferably disposed between the plates 60 and receives the fastener 78a. Locator sleeves 90 are disposed within coiled portions 92 of the biasing element 86. A first end 94 of the biasing element 86 engages and pushes against a pair of spring stops 96 projecting upwardly from upper edges 94 (FIG. 3) of the plates 60 of the frame extension 52. An opposite free end 100 of the biasing element 86 engages an upper surface 102 of, and thus bears down upon and downwardly biases the upper link arm 72.

Opposite the first throughbore 76, preferably located at an end of each of the arms 72, 74 is a second throughbore 104 defining a second pivot connection of each of the arms. Fasteners 106 engage a bracket portion 108 of a receiver tube 110 and also pass through bushings 80 located in the throughbores 104, which in turn are pivotally connected between apertured side plates 112 of the bracket portion. The second pivot connections 104 are vertically displaced and define generally transverse second pivot points. As is the case with the first throughbores 76, the second throughbores 104 are secured to the receiver tube 110 using nuts 82 and washers 84 for tightening the fasteners 106 in place. Also, while other locations are envisioned depending on the application, it is preferred that the first and second pivot connections 76, 104 are located at respective ends of the pivot arms 72, 74.

Thus, it will be seen that the parallelogram linkage 70 is configured so that the receiver tube 110 floats vertically relative to the frame extension 52 under the biasing influence of the biasing element 86, which urges the receiver tube to a lowered position relative to the frame extension 52. While other shapes are contemplated, the receiver tube 110 has a horizontal cross sectional shape of a hollow square tube with rounded corners, and is part of a debris clearing module, generally designated 114, which is connected to the second pivot connections 104 of the two arms 72, 74. It should be noted that the debris-clearing module 114 is located behind the mounting point 58 in the direction of travel 32. This results in the module 114 being “pulled” through the soil 20 instead of being “pushed” as is the case with many conventional crop debris-clearing devices. It is believed that such pushing action enhances the probability of gouging or other misalignment due to uneven soil surfaces. In contrast, the present “pulling” action allows the debris clearing module 114, under the control of the parallelogram linkage 70, to float behind the mounting point 58 over undulations or other irregularities in the soil 20 instead of becoming embedded in them.

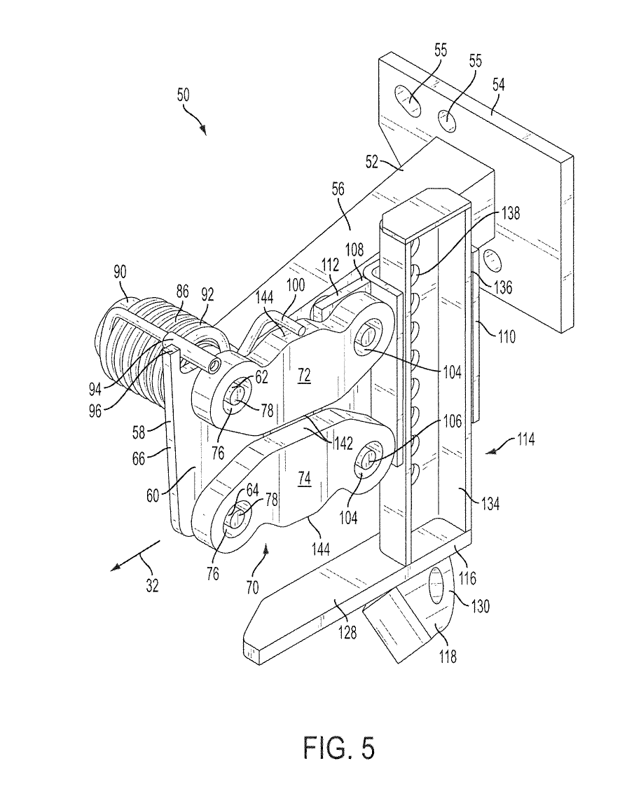

Referring now to FIGS. 2, 4 and 5, included on the debris clearing module 114 is a foot structure 116 configured for supporting at least one disk mount 118 (FIG. 5) constructed and arranged for receiving at least one clearing disk 120. In the preferred embodiment, a pair of disks 120 is provided, but a single disk is considered suitable depending on the application. For the purposes of the present application, a “disk” 120 contemplates a variety of component shapes known in the art, and includes such wheels and wheel-like components having optional teeth or continuous edges, and being planar or dished (convex or concave). While other shapes are contemplated, in the preferred embodiment, the disks 120 are concave facing the direction of travel 32 and have a plurality of generally radially extending teeth 122.

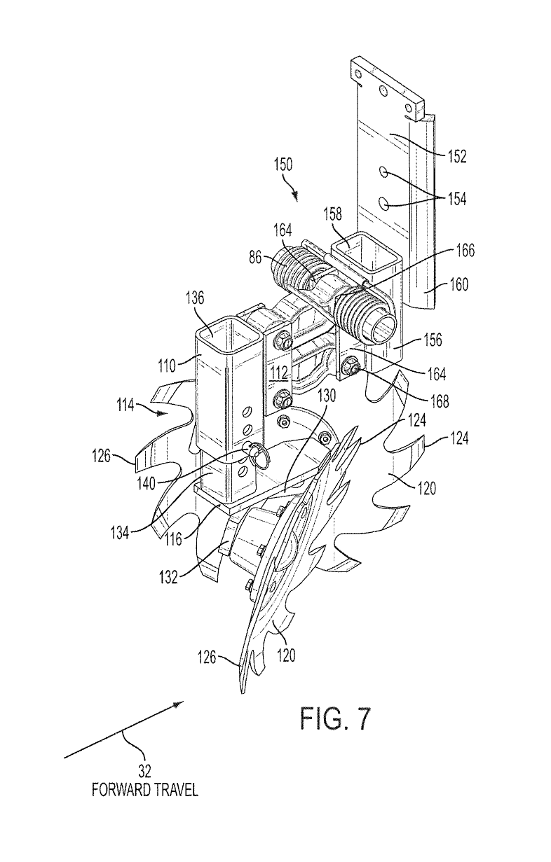

Referring now to FIGS. 4 and 5, it is preferred that the disk mount 118 orient the disks 120 such that the disks converge adjacent one another at a forward reach 124 of the disks, a rearward reach 126 of the disks being spaced apart from one another so that general planes of the disks are angled outwardly from the forward reach to the rearward reach. In addition, the disks 120 are preferably secured to the foot structure 116 to define a spacing in the direction of travel 32 of a specified distance, in the approximate range of 3 to 10 inches, as taught in U.S. Pat. No. 6,279,666 incorporated by reference. As described in the '666 patent, the above-described mounting arrangement of the disks 120 is achieved by providing the foot structure 116 with a horizontal plate 128 to which are affixed, as by welding or the like, a pair of angled side walls 130, 132 (FIGS. 5 and 7), which are oriented at about 15° relative to the vertical such that a plane defined by outer edges of each of the disks rotatably attached to the plates 130, 132 extends outwardly farther than a lower reach.

Referring again to FIG. 5, attached to the horizontal plate 128 is a vertically or upward projecting foot extension or stem 134 slidingly received in the receiver tube 110. The foot extension 134 is configured to fit within a vertical opening 136 within the receiver tube 110. To provide relative vertical adjustability of the foot structure 116 relative to the receiver tube 110, the foot extension 134 and the receiver tube each have a plurality of vertically spaced openings 138 configured for receiving a key pin 140 (FIG. 7). The foot extension 134 is vertically adjustable relative to and within the receiver tube 110 by selectively placing the extension at a desired elevation and inserting the key pin 140 in aligned openings 138 of the foot extension and the receiver tube.

In FIG. 5, the construction of the pivot arms 72, 74 is shown in greater detail. It will be seen that the arms 72, 74 are spaced apart from one another a predetermined distance so that adjacent, opposed surfaces or stop formations 142 of the upper and lower pivot arms 72, 74 can rotate through a predetermined maximum arc relative to any of the first and second pivot connections 76, 104. In the preferred embodiment, the maximum arc is in the range of about 20° to about 40° relative to horizontal in either direction. The predetermined maximum arc is limited by contact between the adjacent stop formations 142 of the pivot arms 72, 74, which are generally flat surfaces.

While other constructions are contemplated, the stop formations 142 extend substantially between the first and second pivot connections 76, 104. During normal operation, the stop formations 142 do not contact each other. When the planter row unit 10 encounters deep holes in the field, or when the row unit is pulled out of the field and elevated for road transport as is known in the art, the weight of the disks 120 pull the parallelogram linkage 70 downward unto the stop formations 142 contact each other.

On each arm 72, 74, opposite the flat stop formation 142 is a spring-engaging surface 144 defining a seat for the free end 100 of the biasing element 86. The biasing element 86 is selected to have sufficient biasing power to provide a designated amount of preload bias that is proportional to a position of the foot structure 116 in the receiver tube 110.

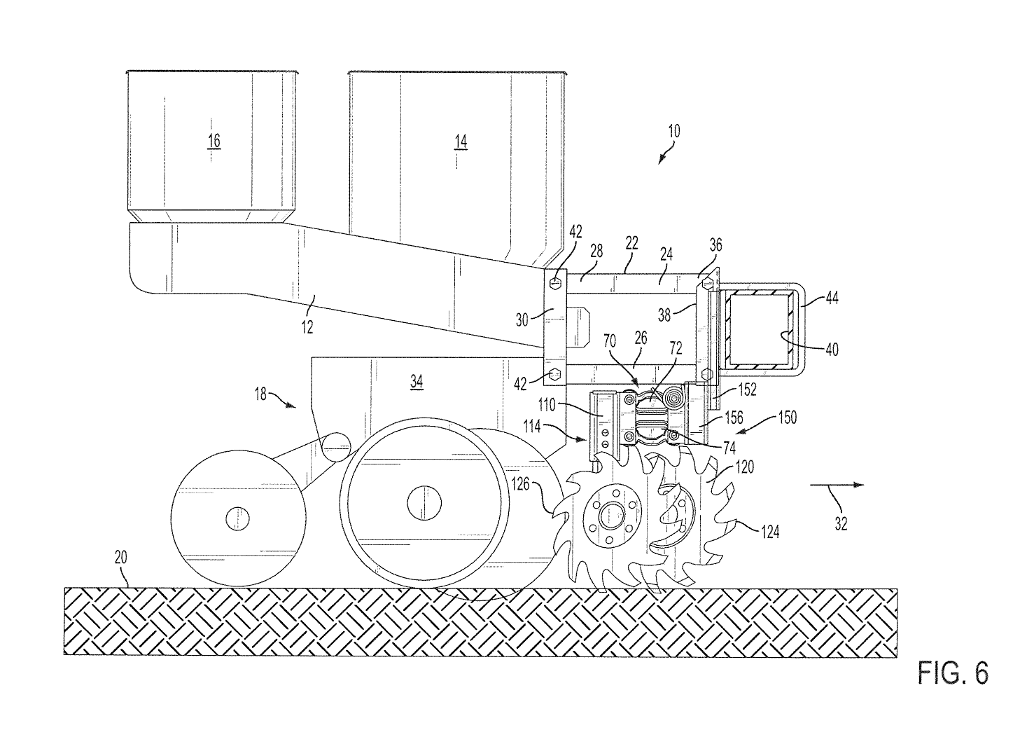

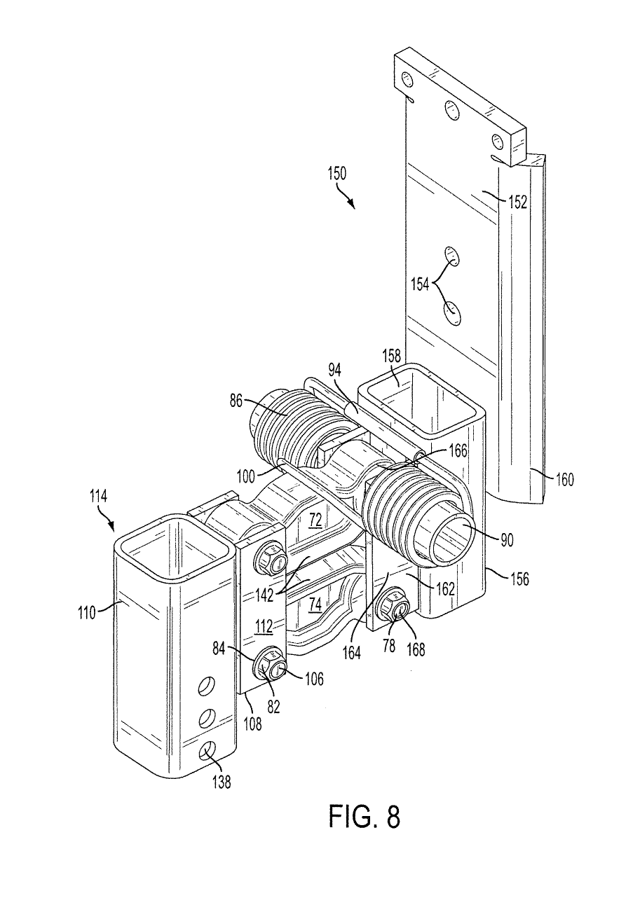

Referring now to FIGS. 6-8, another embodiment of the present debris clearing apparatus is generally designated 150. Components shared with the apparatus 50 are designated with identical reference numbers. A major distinction between the two devices 50, 150 is that the former is mounted to the planter row unit 10, while the latter is mounted to the linkage mounting plate 38, which is eventually attached to the tool bar 40. In other aspects, the two devices 50, 150 operate very similarly, and are both “pulled” through the field in the direction of travel 32. It should be understood that the present debris clearing apparatus 50, 150 is contemplated to be used in conjunction with a variety of agricultural or farm tillage devices, including but not limited to planter row units, implement tool bars, strip till machines and the like, all of which are collectively termed “implements” or “farm implements” in the present application. In all of the operational applications, the debris clearing apparatus 50, 150 is “pulled” through the field in the direction of travel 32.

More specifically, the debris clearing apparatus 150 includes a frame extension 152 taking the form of a generally vertically projecting tool bar plate having at least one mounting aperture 154. Each of the mounting apertures 154 is configured for receiving fasteners such as bolts (not shown) which pass through the linkage mounting plate 38 and secure the tool bar plate 152 to the mounting plate so that it is sandwiched between the linkage mounting plate and the tool bar. It will be understood that, depending on the manufacturer of the planter row unit 10 and the tool bar 40, the specific configuration of the tool bar plate 152 may vary to achieve a secure mounting relationship. Once bolted in place, the tool bar mounting plate 152 should not move when subjected to normal operational forces experienced by the planter row unit 10.

Depending from the frame extension/tool bar plate 152 is a mounting extension 156 which in the preferred embodiment is similar in general configuration to the receiver tube 110 and the bracket portion 108, including a generally vertically extending, preferably tubular portion 158 secured to a lower end 160 of the tool bar plate 152, as by welding or other fastening technology known in the art. The specific configuration of the portion 158 and the mounting location on the tool bar plate 152 is not considered critical and may vary to suit the application.

A bracket portion 162 made of a pair of spaced, generally parallel, rearwardly projecting plates 164 defines a mounting point and is secured to the mounting extension 156. On each of the plates 164 is a pair of vertically spaced, first and second pivot mounts 166, 168 similar in configuration to the pivot mounts 62, 64 defining generally transverse pivot points. The parallelogram linkage 70 is connected to the pivot mounts 166, 168, and the biasing element 86 is connected to the first pivot mount 166 in the same manner as depicted in FIG. 3. However, instead of engaging the spring stops 96, the first end 94 of the biasing element 86 engages the tubular portion 158. Thus, the first pivot mount 166 is termed a bias mount, since the parallelogram linkage 70 is biased in a downward direction by the biasing element 86. As is the case with the debris clearing apparatus 50, the debris-clearing module 114 generally floats behind and is “pulled” relative to the tool bar 40 as the implement is pulled in the direction of travel 32. It will be understood that the debris clearing apparatus 150 operates virtually identically to the apparatus 50.

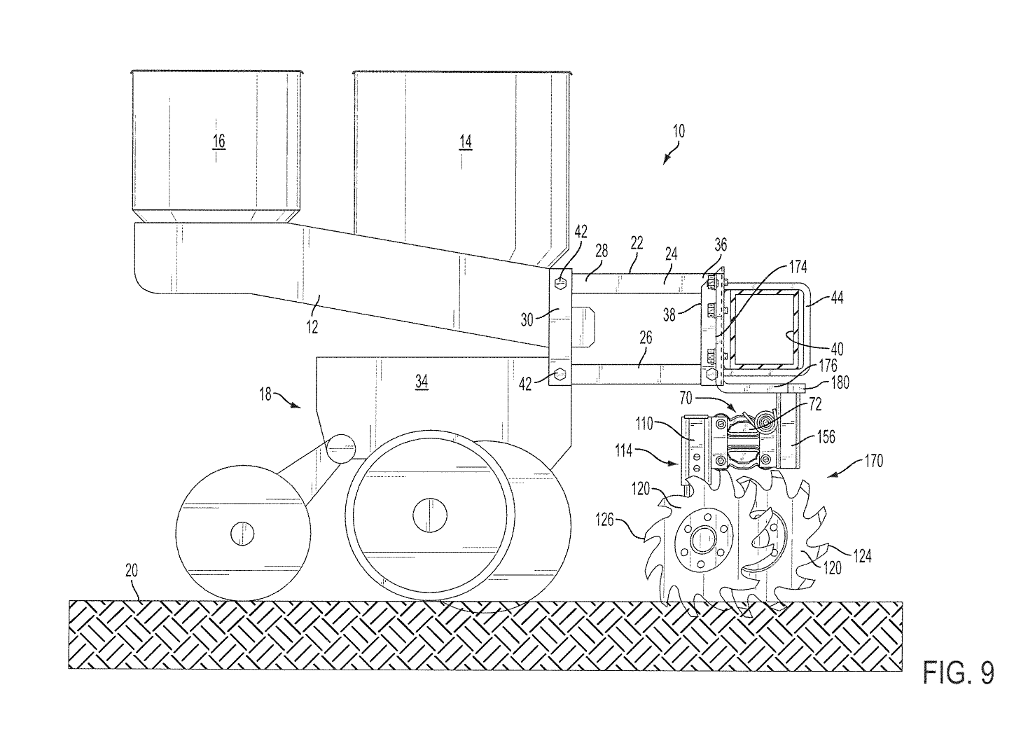

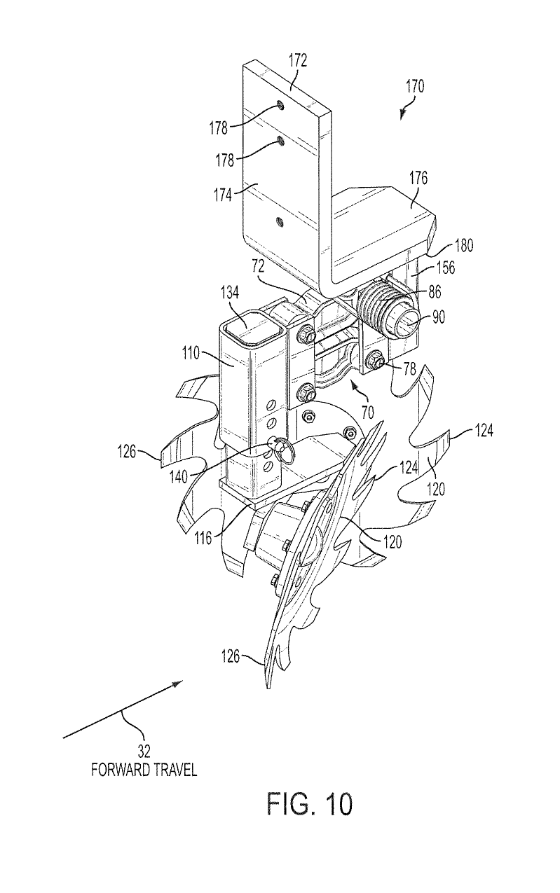

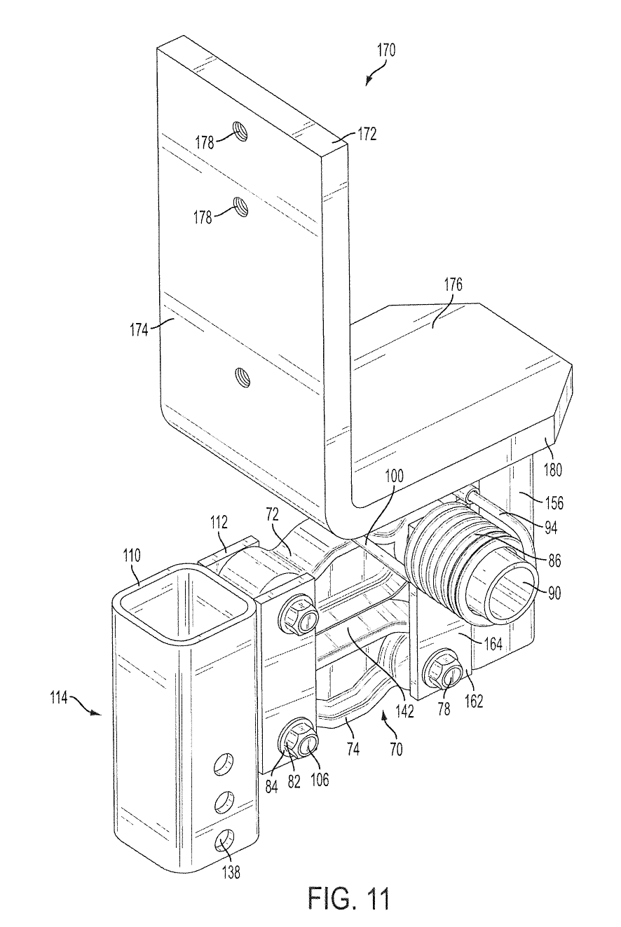

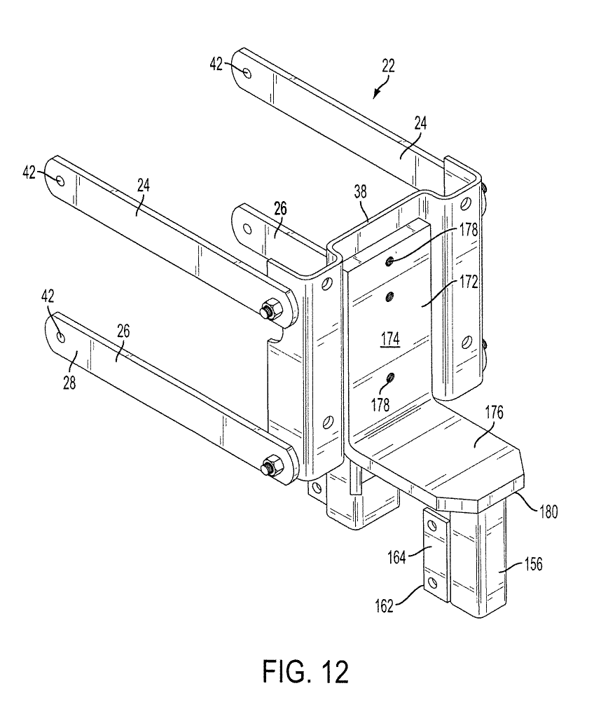

Referring now to FIGS. 9-12, another embodiment of the present debris clearing apparatus is depicted and is generally designated 170. Components shared with the devices 50 and 150 are designated with identical reference numbers. Like the apparatus 150, the apparatus 170 is mounted to the linkage mounting plate 38 (which is connected to the tool bar 40), instead of to the planter row unit 10. However, instead of depending from the mounting plate 38, the frame extension 172 of the apparatus 170 is generally “L”-shaped, having a vertical leg upper portion 174 depending from the mounting plate, and a forwardly projecting leg 176. As is the case with the tool bar plate 152, the vertical leg 174 is sandwiched between the linkage mounting plate 38 and the tool bar 40 and is secured by fasteners passing through mounting apertures 178.

Depending from the forwardly projecting, horizontally oriented leg 176 is the mounting extension 156. However, the mounting extension is secured to an underside 180 of the leg 176, as by welding or the like. As such, the mounting extension 156 extends downwardly from, and forward of the upper portion 174 of the frame extension 172. As is the case with the mounting extension 156 of the apparatus 150, the debris-clearing module 114 is connected to the bracket portion 162 and is pulled through the field in the same manner.

While various embodiments of the present floating apparatus for clearing crop debris have been shown and described, it should be understood that other modifications, substitutions and alternatives are apparent to one of ordinary skill in the art. Such modifications, substitutions and alternatives can be made without departing from the spirit and scope of the invention. Various features of the invention are set forth in the following claims.

What is claimed is:

1. A debris clearing apparatus for use with a farm implement having a tool bar with at least one attached trailing planter row unit having a linkage that permits the planter row unit to generally float relative to the tool bar as the implement is pulled in a direction of travel, said apparatus comprising:
a frame extension configured for connection to the at least one planter row unit and having a mounting point projecting forward from the planter row unit in the direction of travel, said mounting point including generally vertically spaced first and second pivot mounts defining generally transverse pivot points;
a parallelogram linkage having two arms, each said arm having a first pivot connection for attachment to a selected one of said first and second mounts and an opposite second pivot connection;
a debris clearing module configured for attachment to said opposite second pivot connections of said two arms behind said mounting point in the direction of travel, said module having a foot structure for supporting at least one disk mount for receiving at least one clearing disk; and
said parallelogram linkage configured for enabling said debris clearing module to generally float behind said mounting point as the implement is pulled in the direction of travel.

2. The apparatus of claim 1 wherein said second pivot connections are vertically displaced and define generally transverse second pivot points.

3. The apparatus of claim 1 wherein said first pivot mount defines a bias mount accommodating a biasing element for biasing said parallelogram linkage in a downward direction.

4. The apparatus of claim 1 wherein said first and second pivot connections are located at respective ends of said pivot arms.

5. The apparatus of claim 1 wherein said disk mount accommodates a pair of disks oriented such that said disks converge adjacent one another at a forward reach of said disks, a rearward reach of said disks being spaced apart from one another so that general planes of the disks are angled outwardly from said forward reach to said rearward reach.

6. The apparatus of claim 1 wherein said mounting point is defined by a pair of spaced apart first side plates each having vertically spaced attachment points for accommodating said first end pivot connections of said arms, wherein forward edges of said first side plates are connected to each other by a connector member that maintains said spaced relationship.

7. The apparatus of claim 1 wherein said debris clearing module includes a receiver tube having a vertical opening for receiving said foot structure and a pair of spaced apart second side plates configured for pivotally accommodating said second pivot connections of said parallel arms.

8. The apparatus of claim 1 wherein said arms further include a pair of upper and lower pivot arms that are located adjacent one another in a parallel relationship, spaced apart from one another a predetermined distance so that adjacent surfaces of said upper and lower pivot arms can rotate through a predetermined maximum arc relative to any of said first and second pivot connections, said predetermined maximum arc being limited by contact between adjacent stop formations of said upper and lower pivot arms.

9. The apparatus of claim 8 wherein said adjacent stop formations extend substantially between said first and second pivot connections and define generally flat surfaces.

10. The apparatus of claim 8 further including a biasing element-engaging surface opposite said flat surface on each said arm.

11. The apparatus of claim 8 wherein said predetermined arc is within the range of about 20° to about 40° relative to horizontal in either direction.

12. The apparatus of claim 1 wherein said foot structure includes a generally horizontal plate configured for accommodating said disk mount and having an upward elongated foot extension, and said debris clearing module includes a receiver tube, said foot extension being configured to fit within a vertical opening within said receiver tube, said foot extension and said receiver tube each having a plurality of vertically spaced openings configured for receiving a key pin, said foot extension being vertically adjustable in said receiver tube by selectively placing said extension at a desired elevation and inserting said key pin in aligned openings of said foot extension and said receiver tube.

13. The apparatus of claim 1 wherein said first pivot mount is vertically spaced from said second pivot mount and includes a torsion spring having a free end that downwardly biases an upper one of said pivot arms.

14. A debris clearing apparatus for use with a farm implement having a transverse tool bar and at least one trailing planter row unit attached to the tool bar with a linkage that permits the row unit to generally float relative to the tool bar as the implement is pulled in a direction of travel, the linkage being connected to a linkage mounting plate, said apparatus comprising:
a frame extension attachable to the linkage mounting plate, and a mounting extension connected to said frame extension, depending from the linkage mounting plate relative to said direction of travel and including a mounting point including generally vertically spaced first and second pivot mounts defining generally transverse pivot points;
a parallelogram linkage having two arms, each said arm having a first pivot connection for attachment to a selected one of said first and second mounts and an opposite second pivot connection;
a debris clearing module configured for attachment to said opposite second pivot connections of said two arms behind said mounting point in the direction of travel so that said second connections are vertically displaced from each other, said module having a foot structure for supporting at least one disk mount for attaching at least one clearing disk thereto, said parallelogram linkage configured for enabling said debris clearing module to generally float behind and relative to the tool bar as the implement is pulled in the direction of travel.

15. The apparatus of claim 14 wherein said frame extension includes an extension mounting plate configured for being sandwiched between the tool bar and the linkage mounting plate of a planter row unit.

16. The apparatus of claim 14 wherein said first pivot mount defines a bias mount accommodating a biasing element for biasing said parallelogram linkage in a downward direction.

17. The apparatus of claim 14 wherein said mounting point is defined by a pair of spaced apart first side plates each having vertically spaced attachment points for accommodating said first end pivot connections of said arms.

18. The apparatus of claim 14 wherein said arms further include a pair of upper and lower pivot arms that are located adjacent one another in a parallel relationship, spaced apart from one another a predetermined distance so that adjacent surfaces of said upper and lower pivot arms can rotate through a predetermined maximum arc relative to any of said first and second pivot connections, said predetermined maximum arc being limited by contact between said adjacent stop formations of said upper and lower pivot arms.

19. The apparatus as defined in claim 14 wherein said upper extension comprises said generally flat mounting plate with vertically oriented angled wing portions on opposite sides thereof to increase the stiffness of said upper extension.

20. A debris clearing apparatus for use with a farm implement, said apparatus comprising:
a frame extension constructed and arranged for attachment to the farm implement and having a mounting point projecting in the direction of travel, said mounting point including generally vertically spaced first and second pivot mounts defining generally transverse pivot points;
said first pivot mount defines a bias mount accommodating a transversely oriented biasing element for biasing said parallelogram linkage in a downward direction;
a parallelogram two arm linkage, each arm having a first end pivot connection for attachment to said mounting extension and an opposite second end for accommodating a debris clearing module, said second end of each arm having a second end pivot connection;
said arms further include a pair of upper and lower pivot arms that are located adjacent one another in a parallel relationship, spaced apart from one another a predetermined distance so that adjacent surfaces of said upper and lower pivot arms can rotate through a predetermined maximum arc relative to any of said first and second pivot connections, said predetermined maximum arc being limited by contact between adjacent stop formations of said upper and lower pivot arms, a biasing element-engaging surface opposite said flat surface on each said arm;
a debris clearing module configured for attachment to said opposite second pivot connections of said two arms behind said mounting point in the direction of travel so that said second connections are vertically displaced from each other, having a foot structure for supporting at least a pair of disk mounts for attaching a pair of clearing disks thereto, said disk mounts being oriented to position each of said pair of disks to converge adjacent one another at a forward reach of said disks, a rearward reach of each said disk being spaced apart from one another so that the general planes of the disks are angled outwardly from the forward reach to the rearward reach thereof, said disks are preferably secured to the foot structure to define a spacing in the direction of travel of a specified distance; and
said parallelogram linkage configured for enabling said debris clearing module to generally float behind said mounting point as the implement is pulled in the direction of travel.
